(19) United States
(12) Patent Application Publication
(10) Pub. No.: US 2009/0146942 A1
(43) Pub. Date: Jun. 11, 2009

(54) BACKLIGHT APPARATUS, METHOD OF CONTROLLING THE SAME AND LIQUID CRYSTAL DISPLAY APPARATUS HAVING THE SAME

(75) Inventors: Hyoung-Rae LEE, Cheonan-si (KR); Sang-Won LEE, Suwon-si (KR); Ri-Na YOU, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/173,290

(22) Filed: Jul. 15, 2008

(30) Foreign Application Priority Data
Dec. 6, 2007 (KR) 10-2007-0125874

(51) Int. Cl. G02F 1/13357; H05B 41/36

(52) U.S. Cl. 345/102; 315/291; 315/178

(57) ABSTRACT

A backlight apparatus includes a plurality of light source parts, a plurality of transformers and a scanning control part. The light source parts include at least one light source, respectively. The transformers provide the light source parts with power, respectively. The scanning control part drives a first transformer based on a vertical synchronization signal Vsync provided from an external device and sequentially driving at least one of remaining transformers based on a clock signal provided from the external device. Therefore, a light emitting time between light source groups may be made uniform even though an operating frequency corresponding to images is varied, so that a response time of a moving picture may be realized.

This application claims priority to Korean Patent Application No. 2007-125874, filed on Dec. 6, 2007, and all the benefits accruing therefrom under 35 U.S.C. §119, the contents of which in its entirety are herein incorporated by reference.

### BACKGROUND OF THE INVENTION

1. Field of the Invention

The present invention relates to a backlight apparatus, a method of controlling the backlight apparatus, and a liquid crystal display (“LCD”) apparatus having the backlight apparatus. More particularly, the present invention relates to a backlight apparatus emitting a light through a scanning driving method, a method of controlling the backlight apparatus, and an LCD apparatus having the backlight apparatus.

2. Description of the Related Art

A display apparatus displays images by converting electronic data into a visible image, which is processed by an information processing apparatus. Various types of display apparatuses include cathode ray tubes (“CRT”), plasma display panels (“PDP”), liquid crystal display (“LCD”) apparatuses, organic electroluminescent display (“OELD”) apparatuses, etc.

The LCD apparatus displays images by using liquid crystal, of which electrical and optical characteristics vary in response to an electric field applied thereto. The LCD apparatus has been widely used in various electronic apparatuses, because the LCD apparatus offers many advantages, such as light weight, thin thickness, low power consumption, etc., in comparison with other types of display apparatuses.

The LCD apparatus is a non-emissive type display apparatus, and thus the LCD apparatus necessarily requires a light source, such as a backlight apparatus to supply an LCD panel of the LCD apparatus with light.

A conventional LCD apparatus mainly employs a light source, such as a cold cathode fluorescent lamp (“CCFL”), a flat fluorescent lamp (“FFL”), etc., which emits white light.

When a scan signal is applied to gate lines from a gate driving unit, an electric field is formed at the liquid crystal layer by a voltage difference between a common electrode and a pixel electrode, and the direction in which the liquid crystal molecules are arranged is changed according to the applied electric field. The liquid crystal molecules respond to the electric field for a certain length of time. That is, the liquid crystal molecules slowly respond to the electric field, changing their arrangement direction. Because of their viscosity, an elastic restitution force or the like, the liquid crystal molecules slowly respond to the electric field and cannot directly reach a desired light transmittance.

When light is provided to the liquid crystal molecules of an LCD panel in a slow response time, an image that is different from a desire image may be displayed on a screen. Thus, a scanning driving method has been developed, which sequentially blinks each of the light sources in a backlight apparatus on at a time along a scan direction of gate lines. That is, a backlight apparatus is driven by the scanning driving method such that the respective light source is sequentially turned on/off in accordance with a frame driving of the LCD panel.

In the scanning driving method, when an image displayed on a screen and a light source emitting light are not synchronized, a motion picture response time (“MPRT”) is substantially decreased. In order to synchronize the image and the light source, a backlight apparatus receives a vertical synchronization signal (“Vsync”) to synchronize a scanning time of a backlight apparatus.

A backlight apparatus having an operation frequency of about 120 Hz is turned on when the vertical synchronization signal (Vsync) is inputted thereto. The backlight apparatus counts the number of internal clocks. The backlight apparatus is turned off when the count value arrives at a predetermined number, and the backlight apparatus is turned on when a vertical synchronization signal (Vsync) is inputted thereto.

For example, in a backlight apparatus adopted in an LCD apparatus set by an operation frequency of about 120 Hz, when two light source groups are driven in the scanning driving method based on a vertical synchronization signal (Vsync), a first light source group is emitted for an initial time of 4.17 ms and a second light source group is emitted for the remaining time of 4.17 ms.

When the operation frequency of the LCD apparatus is changed from about 120 Hz to about 110 Hz, a first light source group is emitted for an initial time of 4.17 ms, and a second light source group is emitted for the remaining time of 4.92 ms.

### BRIEF SUMMARY OF THE INVENTION

It has been determined, according to the present invention, that when an operation frequency of a liquid crystal display (“LCD”) apparatus is changed, an image displayed on a screen and a light source emitting light may not be synchronized. Thus, when a variation between an operation frequency initially set and an operation frequency currently used is increased, a variation of emitting time between the light source groups is increased. Accordingly, a motion picture response time (“MPRT”) may be decreased in a conventional LCD apparatus.

The present invention provides a backlight apparatus capable of uniformizing a light emitting time between light source groups even though an operating frequency corresponding to images is varied.

The present invention also provides a method of controlling the above-mentioned backlight apparatus.

The present invention also provides an LCD apparatus having the above-mentioned backlight apparatus.

In exemplary embodiments of the present invention, a backlight apparatus include a plurality of light source parts, a plurality of transformers and a scanning control part. Each of the light source parts includes at least one light source. The transformers provide the light source parts with power, respectively. The scanning control part drives a first transformer based on a vertical synchronization signal Vsync provided from an external device and sequentially drives at least one of remaining transformers based on a clock signal provided from the external device.

In an exemplary embodiment, the clock signal may be one of a horizontal synchronization signal Hsync, a load signal TP which instructs outputting of an image data signal to a plurality of data lines after the image data signal is transferred to the data lines, and a clock pulse vertical signal CPV which controls an output of gate on/off signals.

In an exemplary embodiment, the scanning control part may count the clock signal to control driving of the transformers sequentially.

In an exemplary embodiment, the scanning control part may control power that is provided to the first transformer in response to the vertical synchronization signal Vsync, protect the power provided to an (n)-th transformer when a count number of the clock signal is conditioned by a predetermined number, and control power that is provided to an (n+1)-th transformer part, wherein ‘n’ is a natural number. Here, the predetermined number is a value of a clock number corresponding to one frame divided by the number of the light source parts.

In an exemplary embodiment, the scanning control part may include a clock counter and a switch. The clock counter may count the vertical synchronization signal Vsync and the clock signal to output a high signal or a low signal. The switch may control a driving of at least one of the transformers based on the high signal or the low signal.

In an exemplary embodiment, each of the light sources may include a cold cathode florescent lamp (“CCFL”), an external electrode florescent lamp (“EEFL”) and a light-emitting diode (“LED”).

In an exemplary embodiment, the scanning control part may control that each of the transformers has a substantially identical activation interval.

In an exemplary embodiment, the backlight apparatus may include a power providing part and a switching part. The power providing part may include a plurality of metal-oxide semiconductor (“MOS”) transistors in a full-bridge arrangement. The switching part may be electrically connected to the transformers and the power providing part to optionally provide the transformers with power outputted from the power providing part in response to a control of the scanning control part.

In other exemplary embodiments of the present invention, a method of driving a backlight apparatus including a plurality of light source parts includes (i) activating a first light source part based on a vertical synchronization signal Vsync; (ii) counting a clock signal inputted from an external device; (iii) deactivating an activated light source part as a count value is conditioned by a predetermined number, and activating a following light source part; (iv) resetting the count value; (v) checking whether a vertical synchronization signal Vsync is inputted or not, and feedbacking step (i) when the vertical synchronization signal Vsync is inputted; and (vi) feedbacking step (ii) when the vertical synchronization signal Vsync is not inputted in step (v).

In still other exemplary embodiments of the present invention, an LCD apparatus includes an LCD part having an LCD panel, and a backlight apparatus providing the LCD panel with a light. The LCD part includes a timing control part, a data driving part, a gate driving part and the LCD panel. The timing control part receives a first image signal and a synchronization signal from an external device to output a second image signal, a first control signal and a second control signal. The data driving part outputs a plurality of data voltages based on the second image signal and the first control signal. The gate driving part outputs a plurality of gate voltages based on the second control signal. The LCD panel displays an image based on the gate voltages and the data voltages. The backlight apparatus includes a plurality of light source parts, a plurality of transformers and a scanning control part. Each of the light source parts includes at least one light source. The transformers provide the light source parts with power, respectively. The scanning control part drives a first transformer based on a vertical synchronization signal Vsync provided from an external device and sequentially drives at least one of remaining transformers based on a clock signal provided from the external device.

In an exemplary embodiment, the clock signal may include a horizontal synchronization signal Hsync provided from a graphic controller to the timing control part.

In an exemplary embodiment, the clock signal may be a load signal TP included in the first control signal to instruct an outputting of an image data signal to a plurality of data lines after the image data signal is transferred to the data lines.

In an exemplary embodiment, the clock signal may be a clock pulse vertical signal CPV included in the second control signal to control an output of gate on/off signals corresponding to the gate voltage.

According to a backlight apparatus, a method of controlling the backlight apparatus and an LCD apparatus having the backlight apparatus, a light emitting time between light source groups may be made uniform even when an operating frequency corresponding to images is varied, so that a response time of a moving picture may be realized.

### BRIEF DESCRIPTION OF THE DRAWINGS

The above and other features and advantages of the present invention will become readily apparent by reference to the following detailed description when considered in conjunction with the accompanying drawings wherein:

FIG. 1 is a block diagram illustrating an exemplary backlight apparatus according to one exemplary embodiment of the present invention;

FIG. 2 is a waveform diagram illustrating an exemplary light source driving signal of FIG. 1;

FIG. 3 is a block diagram illustrating an exemplary backlight apparatus according to another exemplary embodiment of the present invention;

FIG. 4 is a flowchart illustrating an exemplary method of driving an exemplary backlight apparatus according to one exemplary embodiment of the present invention;

FIG. 5 is a block diagram illustrating an exemplary liquid crystal display (“LCD”) apparatus according to one exemplary embodiment of the present invention;

FIG. 6 is a block diagram illustrating an exemplary switching part of FIG. 5;

FIGS. 7A to 7C are waveform diagrams illustrating exemplary light source driving signals; and

FIG. 8 is a waveform diagram illustrating an exemplary light source driving signal according to another exemplary embodiment of the present invention.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

FIG. 1 is a block diagram illustrating an exemplary backlight apparatus according to one exemplary embodiment of the present invention.

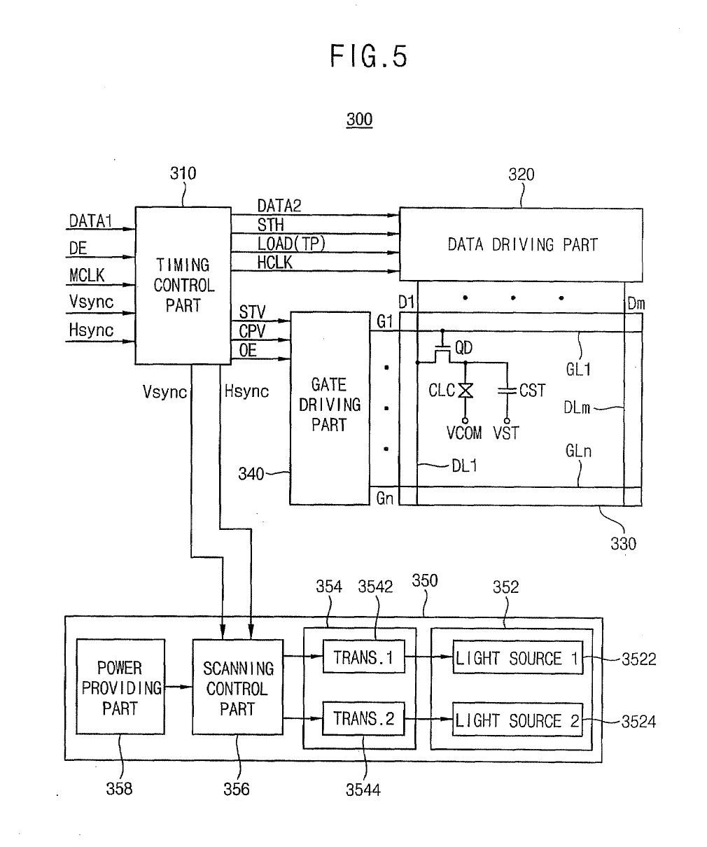

Referring to FIG. 1, a backlight apparatus 100 according to one exemplary embodiment of the present invention includes a light source group part 110, a transformer part 120 and a scanning control part 130, and provides a liquid crystal display (“LCD”) panel (such as shown in FIG. 5) with light.

The light source group part 110 includes a first light source group 112, a second light source group 114, a third light source group 116 and a fourth light source group 118. Each of the first to fourth light source groups 112, 114, 116 and 118 includes at least one light source. The light source may include a cold cathode fluorescent lamp (“CCFL”), an external electrode fluorescent lamp (“EEFL”) and a light-emitting diode (“LED”). While the light source group part 110 is shown and described as including four light source groups, it should be understood that an alternate number of light source groups may be included within the light source group part 110.

The transformer part 120 includes a first transformer 122, a second transformer 124, a third transformer 126 and a fourth transformer 128, and provides the light source group part 110 electrically connected thereto with power. In this embodiment, the first to fourth transformers 122, 124, 126 and 128 are electrically connected to the first to fourth light source groups 112, 114, 116 and 118 in a one-to-one correspondence. Alternatively, the first to fourth transformers 122, 124, 126 and 128 may be electrically connected to the first to fourth light source groups 112, 114, 116 and 118 in a one-to-plural correspondence. While the transformer part 120 is shown and described as including four transformers, it should be understood that an alternate number of transformers may be included within the transformer part 120.

The scanning control part 130 drives the first transformer 122 based on a vertical synchronization signal Vsync provided from an external device, and sequentially drives the remaining transformers 124, 126 and 128 based on a clock signal CLK provided from an external device.

In this embodiment, the clock signal CLK may be one of a horizontal synchronization signal Hsync, a load signal TP for instructing to output an image data signal to a plurality of data lines after the image data signal is transferred to the data lines, and a clock pulse vertical signal CPV for controlling an output of gate on/off signals.

The vertical synchronization signal Vsync represents a time required for displaying one frame field. The horizontal synchronization signal Hsync represents a time required for displaying one line of the one frame field. Thus, the horizontal synchronization signal Hsync includes a plurality of pulses corresponding to the number of pixels included in one line.

The scanning control part 130 counts the clock signal CLK to control sequential driving of the transformer part 120. That is, the scanning control part 130 controls power that is provided to the first transformer 122 in response to the vertical synchronization signal Vsync, protects the power provided to the first transformer 122 when the count number of the clock signal CLK is conditioned by a predetermined number, and controls power that is provided to the second transformer 124. In this embodiment, the predetermined number is a value where a clock number corresponding to one frame is divided by the number of light source groups in the light source group part 110.

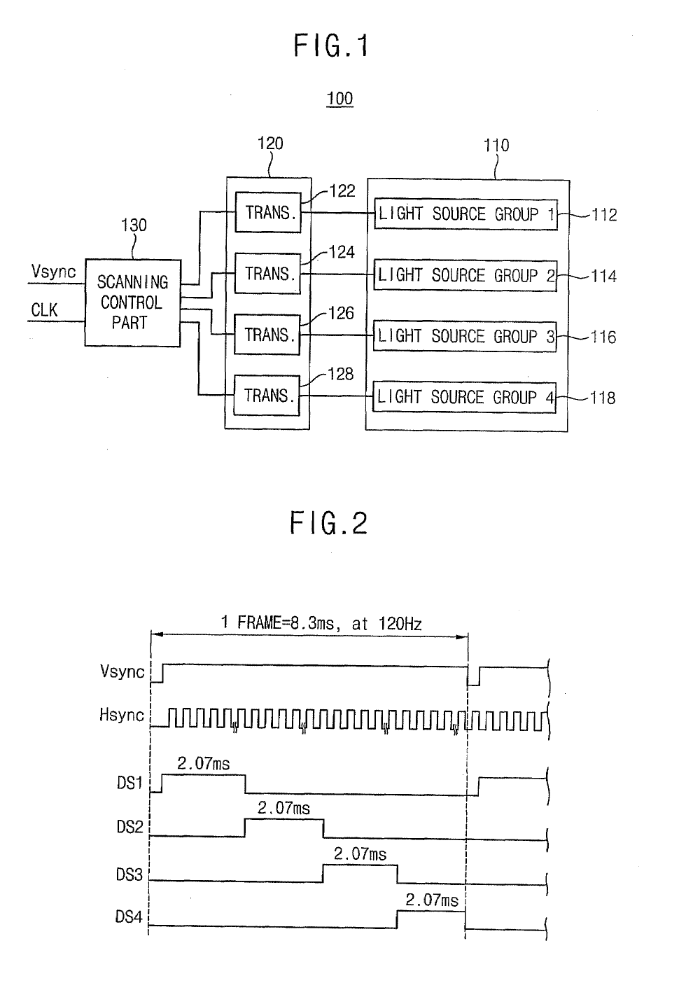

FIG. 2 is a waveform diagram illustrating an exemplary light source driving signal of FIG. 1. In this embodiment, driving of the transformers 122 to 128 based on a vertical synchronization signal Vsync and a horizontal synchronization signal Hsync will be described.

Referring to FIGS. 1 and 2, when a vertical synchronization signal Vsync is converted from a low level to a high level, the scanning control part 130 outputs a first driving signal DS1 to the first transformer 122. In this embodiment, one frame corresponds to a frequency of about 120 Hz. Thus, a time corresponding to one frame is about 8.3 ms.

After the first driving signal DS1 is outputted, the scanning control part 130 counts a number of a horizontal synchronization signal Hsync. As the number of the horizontal synchronization signal Hsync is arrived at a predetermined number, the scanning control part 130 protects an outputting of the first driving signal DS1, and outputs a second driving signal DS2 to the second transformer 124. In this embodiment, where four light source groups are included in the light source group part 110, a time that the first driving signal DS1 is outputted is about 2.07 ms.

After the second driving signal DS2 is outputted, the scanning control part 130 counts the number of the horizontal synchronization signal Hsync. As the number of the horizontal synchronization signal Hsync is arrived at a predetermined number, the scanning control part 130 protects an outputting of the second driving signal DS2, and outputs a third driving signal DS3 to the third transformer 126. In this embodiment, a time that the second driving signal DS2 is outputted is about 2.07 ms.

After the third driving signal DS3 is outputted, the scanning control part 130 counts the number of the horizontal synchronization signal Hsync. As the number of the horizontal synchronization signal Hsync is arrived at a predetermined number, the scanning control part 130 protects an outputting of the third driving signal DS3, and outputs a fourth driving signal DS4 to the fourth transformer 128. In this embodiment, a time that the third driving signal DS3 is outputted is about 2.07 ms.

After the fourth driving signal DS4 is outputted, the scanning control part 130 counts the number of the horizontal synchronization signal Hsync. As the number of the horizontal synchronization signal Hsync is arrived at a predetermined number, the scanning control part 130 protects an outputting of the fourth driving signal DS4, and outputs the first driving signal DS1 to the first transformer 122. In this embodiment, a time that the fourth driving signal DS4 is outputted is about 2.07 ms.

It should be understood that the number of driving signals and the time that each of the driving signals are outputted depends on the number of light source groups included in the light source group part 110.

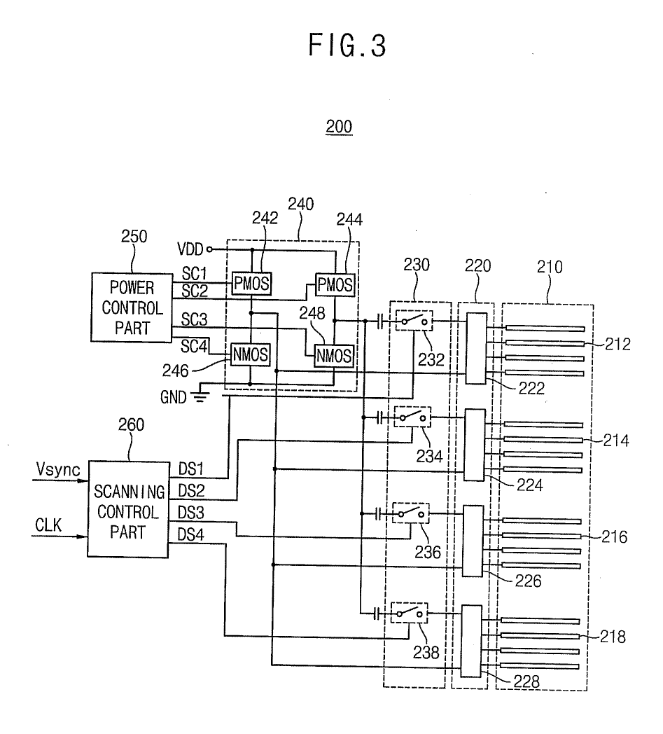

FIG. 3 is a block diagram illustrating an exemplary backlight apparatus 200 according to another exemplary embodiment of the present invention.

Referring to FIG. 3, a backlight apparatus 200 according to another exemplary embodiment of the present invention includes a light source group part 210, a transformer part 220, a switching part 230, a power providing part 240, a power control part 250 and a scanning control part 260, and provides an LCD panel (such as shown in FIG. 5) with light.

The light source group part 210 includes a first light source group 212, a second light source group 214, a third light source group 216 and a fourth light source group 218. While the light source group part 210 is shown and described as including four light source groups, it should be understood that an alternate number of light source groups may be included within the light source group part 210.

The transformer part 220 includes a first transformer 222, a second transformer 224, a third transformer 226 and a fourth transformer 228. While the transformer part 220 is shown and described as including four transformers, it should be understood that an alternate number of transformers may be included within the transformer part 220.

The switching part 230 includes a first switch 232, a second switch 234, a third switch 236 and a fourth switch 238. The number of switches in the switching part 230 may correspond to the number of transformers in the transformer part 220.

The power providing part 240 includes four metal-oxide semiconductor (“MOS”) transistors electrically connected to each other in a full-bridge arrangement. In this embodiment, a source of each of a first p-type MOS (“PMOS”) transistor 242 and a second PMOS transistor 244 is electrically connected to a power voltage terminal VDD, and a drain of each of a first n-type MOS (“NMOS”) transistor 246 and a second NMOS transistor 248 is electrically connected to a ground terminal GND. A drain of the first PMOS transistor 242 is electrically connected to a source of the first NMOS transistor 246. A drain of the second PMOS transistor 244 is electrically connected to a source of the second NMOS transistor 248.

A first switching control signal SC1 and a second switching control signal SC2, which are provided from the power control part 250, are provided to gates of the first and second PMOS transistors 242 and 244, respectively. A third switching control signal SC3 and a fourth switching control signal SC4, which are provided from the power control part 250, are provided to gates of the first and second NMOS transistors 246 and 248, respectively.

In an operation, when the first and third switching control signals SC1 and SC3 are at a low level and the second and fourth switching control signals SC2 and SC4 are at a high level, a power voltage VDD is applied to a first terminal of the transformer part 220 directly connected to the power providing part 240, and a ground voltage GND is applied to a second terminal of the transformer part 220 electrically connected to the power providing part 240 via the switching part 230.

Moreover, when the first and third switching control signals SC1 and SC3 are at a high level and the second and fourth switching control signals SC2 and SC4 are at a low level, a ground voltage GND is applied to the first terminal of the transformer part 220 directly connected to the power providing part 240, and a power voltage VDD is applied to the second terminal of the transformer part 220 electrically connected to the power providing part 240 via the switching part 230.

The scanning control part 260 turns on the first switch 232 based on a vertical synchronization signal Vsync provided from an external device (not shown), and sequentially turns on the remaining switches 234, 236 and 238 based on a clock signal CLK provided from an external device (not shown). In this embodiment, the clock signal is one of a horizontal synchronization signal Hsync, a load signal TP for instructing to output an image data signal to a plurality of data lines of the LCD panel after the image data signal is transferred to the data lines, and a clock pulse vertical signal CPV for controlling an output of gate on/off signals. For example, the load signal TP may instruct conversion of an image data signal into corresponding data voltages and an output of the data voltage to a data driving part after the image data signal is transferred to the data lines. The horizontal synchronization signal Hsync represents a time required for displaying one line of the frame. Thus, the horizontal synchronization signal Hsync includes pulses corresponding to the number of pixels included in one line.

The scanning control part 260 counts the number of the clock signal CLK to control a sequential turning on of the first to fourth switches 232, 234, 236 and 238. That is, the scanning control part 260 turns on the first switch 232 to control power that is provided to the first transformer 222 in response to the vertical synchronization signal Vsync. Moreover, when the count number of the clock signal CLK is arrived at a predetermined number, the scanning control part 260 turns off the first switch 232 to protect the power provided to the first transformer 222, and turns on the second switch 234 to control power that is provided to the second transformer 224. In this embodiment, the predetermined number is a value that is the number of a clock corresponding to one frame is divided by the number of the light source groups 212, 214, 216 and 218.

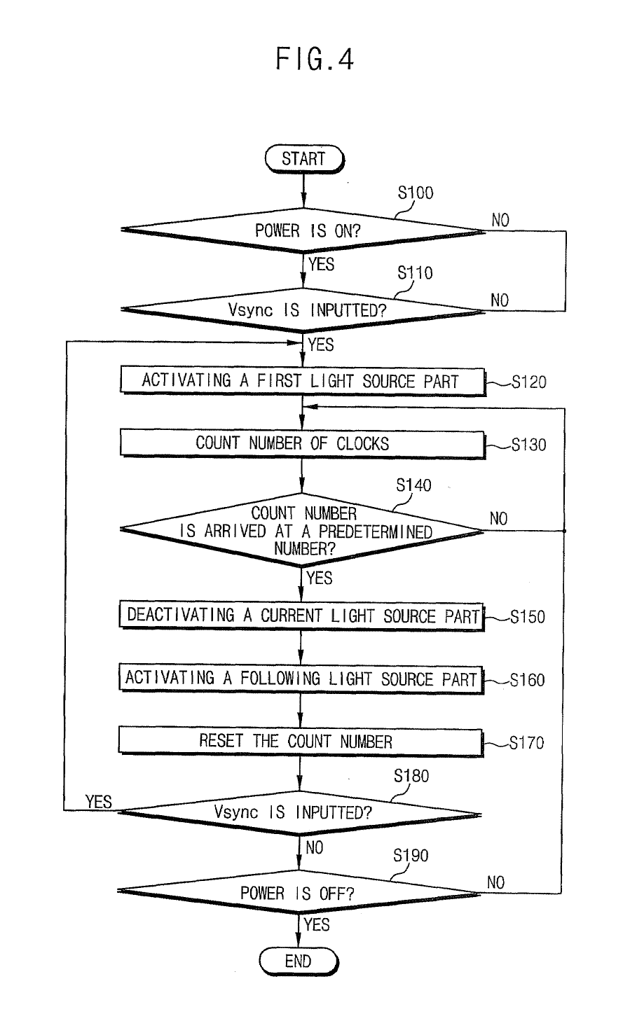

FIG. 4 is a flowchart illustrating an exemplary method of driving an exemplary backlight apparatus according to one exemplary embodiment of the present invention.

Referring to FIG. 4, it is checked whether or not a power of a backlight apparatus is turned on (step S100).

In step S100, when it is determined that the power of the backlight apparatus is turned on, it is then checked whether or not a vertical synchronization signal Vsync is inputted from an external device (step S110).

In step S110, when it is determined that the vertical synchronization signal Vsync is inputted from an external device, then a first light source part is activated (step S120). In an exemplary embodiment, the first light source part may include at least one of light sources electrically connected to each other. The first light source may be disposed in correspondence with a plurality of gate lines including a first gate line of an LCD panel.

Then, the number of clock signal provided from an external device is counted (step S130). The clock signal may be one of a horizontal synchronization signal Hsync, a load signal TP for instructing to output an image data signal to a plurality of data lines after the image data signal is transferred to the data lines, and a clock pulse vertical signal CPV for controlling an output of gate on/off signals.

Then, it is checked whether or not the counted clock number is arrived at a predetermined number (step S140). The predetermined number is a value that the clock number corresponding to one frame is divided by the number of the light source parts.

When it is checked that the counted clock number has not arrived at a predetermined number in step S140, it is fed back to step S130, and when it is checked that the counted clock number has arrived at a predetermined number, the light source part that is currently emitting light is deactivated (step S150).

Then, a following light source part is activated (step S160), and the counted value is reset (step S170). For example, when the light source part that is currently activated to emit light is a first light source part, the following light source part is a second light source part adjacent to the first light source part. Moreover, when the light source part that is currently activated to emit light is a second light source part, the following light source part is a third light source part adjacent to the second light source part. In such an arrangement, the light source parts are sequentially activated.

Then, it is checked whether or not a vertical synchronization signal Vsync is inputted, which is different from the vertical synchronization signal Vsync inputted in step S110 (step S180). When it is determined that the vertical synchronization signal Vsync is inputted, it is fed back to step S120.

When it is determined that the vertical synchronization signal Vsync is not inputted in step S180, it is checked whether or not a power is off (step S190). In step S190, when it is determined that the power is off, the process is finished, and when it is determined that the power is not off, it is fed back to step S130.

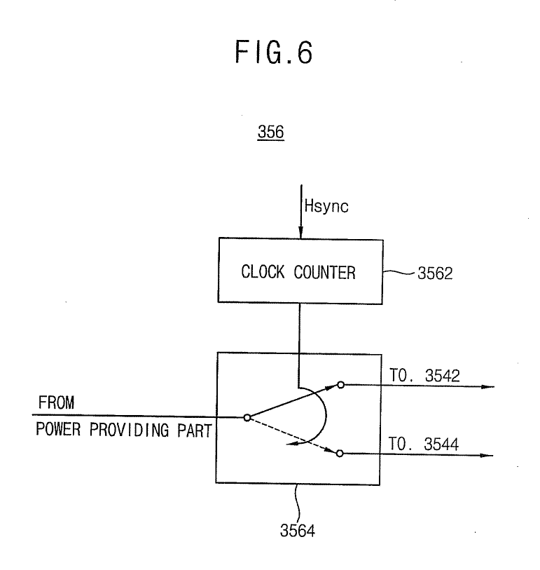

FIG. 5 is a block diagram illustrating an exemplary LCD apparatus 300 according to one exemplary embodiment of the present invention. FIG. 6 is a block diagram illustrating an exemplary scanning control part 356 of FIG. 5.

Referring to FIGS. 5 and 6, an LCD apparatus 300 includes a timing control part 310, a data driving part 320, an LCD panel 330, a gate driving part 340 and a backlight apparatus 350. The timing control part 310, the data driving part 320, the LCD panel 330 and the gate driving part 340 may define an LCD part that displays an image using a liquid crystal layer (not shown).

The timing control part 310 receives a first image signal DATA1 and a synchronization signal from an external host system such as a graphic controller (not shown). The timing control part 310 outputs a second image signal DATA2 and a first control signal to the data driving part 320, and outputs a second control signal to the gate driving part 340.

The first and second image signals DATA1 and DATA2 include red, green and blue (“RGB”) data. The synchronization signal includes a main clock MCLK, a data enable signal DE, a vertical synchronization signal Vsync and a horizontal synchronization signal Hsync. The data enable signal DE represents a time required for supplying the pixel with a data. Therefore, the horizontal synchronization signal Hsync includes a plurality of pulses corresponding to the number of pixels included in one line.

The first control signal includes a load signal TP for outputting the second image signal DATA2, a horizontal start signal STH and a polarity control signal REV. The second control signal includes a start pulse vertical signal STV, a clock pulse vertical signal CPV or GLK and an output enable signal OE. The load signal TP and the clock pulse vertical signal CPV correspond to one line. That is, as the number of gate lines of the LCD panel 330 increases, the numbers of the load signal TP and the clock pulse vertical signal CPV increase.

The data driving part 320 provides the LCD panel 330 with a plurality of image data (i.e., data voltages) based on the second image signal DATA2 and the first control signal.

In an exemplary embodiment, the data driving part 320 may include a printed circuit board (“PCB”), a flexible PCB (“FPCB”) electrically connected to the PCB, and one or more data driving chips that are mounted on the FPCB. In another exemplary embodiment, the data driving part 320 may be mounted on a peripheral area of the LCD panel 330.

The LCD panel 330 includes a plurality of gate lines GL1 to GLn, a plurality data lines DL1 to DLm, a switching element QD electrically connected to the gate line and the data line, a liquid crystal capacitor CLC electrically connected to the switching element QD and a storage capacitor CST electrically connected to the switching element QD. The switching element QD may include a thin-film transistor (“TFT”). The TFT may include an amorphous silicon (“a-Si”) TFT.

In operation, the gate line GL transfers the gate voltage to the switching element QD. The data line DL transfers the data voltage to the switching element QD. The liquid crystal capacitor CLC is turned on/off based on the gate voltage, thereby charging the data voltage. The storage capacitor CST stores the data voltage through the turned-on switching element QD, and provides the liquid crystal capacitor CLC with the charged data voltage during a turned-off time interval of the switching element QD.

The gate driving part 340 sequentially provides the LCD panel 330 with a plurality of gate voltages based on the second control signal.

In an exemplary embodiment, the gate driving part 340 includes a PCB, an FPCB electrically connected to the PCB, and one or more gate driving chips that are mounted on the FPCB.

In another exemplary embodiment, the gate driving part 340 includes an FPCB and one or more gate driving chips that are mounted on the FPCB. In still another exemplary embodiment, the gate driving part 340 may be mounted on a peripheral area of the LCD panel 330.

The backlight apparatus 350 includes a light source part 352, a transformer part 354, a scanning control part 356 and a power providing part 358, and sequentially provides the LCD panel 330 with light.

The light source part 352 includes a first light source 3522 and a second light source 3524. In an alternative exemplary embodiment, the light source part 352 may include more than two light sources. The first and second light sources 3522 and 3524 include at least one light source, respectively. The light source may include a CCFL, an EEFL and an LED. In an exemplary embodiment, the first light source 3522 is disposed in correspondence with a first gate line receiving a first gate signal G1 through an (n/2)-th gate line receiving an (n/2)-th gate signal. Moreover, the second light source 3524 and the first light source 3522 are disposed in correspondence with an (n/2+1)-th gate line receiving an (n/2+1)-th gate signal through an (n)-th gate line receiving an (n)-th gate signal Gn.

The transformer part 354 includes a first transformer 3542 and a second transformer 3544, and provides the light source part 352 electrically connected thereto with a power. In an alternative exemplary embodiment, the transformer part 354 may include more than two transformers.

The scanning control part 356 drives the first transformer 3542 based on the vertical synchronization signal Vsync provided from an external device, and drives the second transformer 3544 based on a horizontal synchronization signal Hsync provided from an external device. In an exemplary embodiment shown in FIG. 6, the scanning control part 356 includes a clock counter 3562 and a switch 3564. The clock counter 3562 controls the switch 3564 so as to drive the second transformer 3544 in response to the horizontal synchronization signal Hsync.

In this exemplary embodiment, the backlight apparatus 350 sequentially provides the LCD panel 330 with light based on the vertical synchronization signal Vsync and the horizontal synchronization signal Hsync.

In another exemplary embodiment, the backlight apparatus 350 sequentially provides the LCD panel 330 with light based on the vertical synchronization signal Vsync and the load signal TP.

In yet another exemplary embodiment, the backlight apparatus 350 sequentially provides the LCD panel 330 with light based on the vertical synchronization signal Vsync and the clock pulse vertical signal CPV.

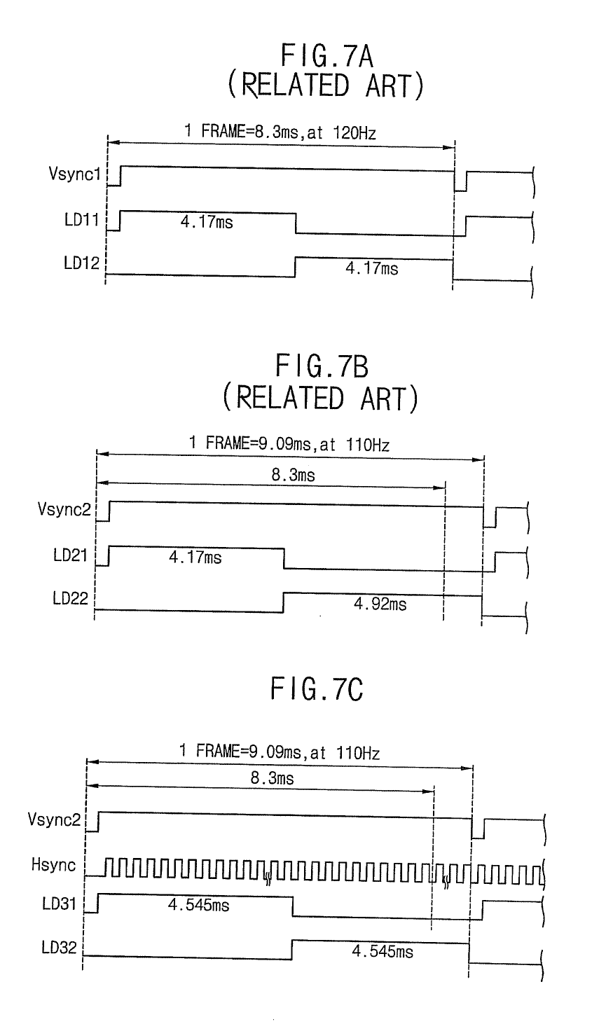

FIGS. 7A to 7C are waveform diagrams illustrating exemplary light source driving signals. A plurality of light source driving signals is described for ease of understanding, which is provided to a backlight apparatus having two light source groups.

Referring to FIG. 7A, when an operating frequency of an LCD device is about 120 Hz, a time corresponding to one frame is about 8.3 ms.

In an operation, a conventional backlight apparatus applies a first light source driving signal LD11 for driving a first light source group to a first transformer in response to a vertical synchronization signal Vsync.

Then, the conventional backlight apparatus counts the number of an internal clock. When the number of the internal clock is arrived at a predetermined number, the conventional backlight apparatus protects the first light source driving signal LD11 applied to the first transformer, and applies a second light source driving signal LD12 for driving a second light source group.

Therefore, a first light source driving signal LD11 is applied to the first transformer for a time of about 4.17 ms, and the second light source driving signal LD12 is applied to the second transformer for a time of about 4.17 ms.

The predetermined number of the internal clock is a value that is set in a backlight apparatus operated in a frequency of about 120 Hz. Therefore, even though an operating frequency of an LCD apparatus is changed, the predetermined number of the internal clock is not changed.

Hereinafter, when an operation frequency of an LCD apparatus is changed to about 110 Hz, first and second light source driving signals applied to the first and second transformers, respectively, will be described with reference to FIG. 7B.

Referring to FIG. 7B, when an operation frequency of an LCD apparatus is changed from about 120 Hz to about 110 Hz, a time corresponding to one frame is about 9.09 ms.

In an operation of an LCD apparatus having a conventional backlight apparatus, the conventional backlight apparatus applies a first light source driving signal LD21 for driving a first light source group to a first transformer in response to a vertical synchronization signal Vsync.

Then, the conventional backlight apparatus counts the number of an internal clock. When the number of the internal clock is arrived at a predetermined number, the conventional backlight apparatus protects the first light source driving signal LD21 applied to the first transformer, and applies a second light source driving signal LD22 for driving a second light source group. As the predetermined number of the internal clock is a value that is set in a backlight apparatus operated in a frequency of about 120 Hz, the first light source driving signal LD21 is applied to the first transformer for a time of about 4.17 ms, and the second light source driving signal LD22 is applied to the second transformer for the remaining time that is about 4.92 ms. Therefore, when an operating frequency of an LCD apparatus having the conventional backlight apparatus is changed, a variation of emitting time between the light source groups of the conventional backlight apparatus is generated.

However, according to the present invention, even when an operation frequency of an LCD apparatus is changed, a variation of emitting time between the light source groups is not substantially generated.

Referring to FIGS. 5 and 7C, when an operation frequency of an LCD apparatus is changed from about 120 Hz to about 110 Hz, a time corresponding to one frame is about 9.09 ms.

In an operation, a scanning control part 356 according to one exemplary embodiment of the present invention applies a first light source driving signal LD31 for driving a first light source group to a first transformer 3542 in response to a vertical synchronization signal Vsync.

Then, the scanning control part 356 counts the number of a horizontal synchronization signal Hsync. When the number of the horizontal synchronization signal Hsync is arrived at a predetermined number, the scanning control part 356 protects the first light source driving signal LD31 applied to the first transformer 3542, and applies a second light source driving signal LD32 for driving a second light source group to the second transformer 3544. In this exemplary embodiment, the predetermined number is a value that the numbers of the horizontal synchronization signal Hsync corresponding to one frame is divided by the number of the light source parts. Therefore, the first light source driving signal LD31 is applied to the first transformer 3542 for a time of about 4.545 ms, and the second light source driving signal LD32 is applied to the second transformer 3544 the remaining time that is about 4.545 ms.

Therefore, even when an operating frequency of an LCD apparatus is changed, the light source driving signals for driving the light source groups that are adopted in the changed operation frequency are provided, so that a variation of emitting time between the light source groups is not substantially generated.

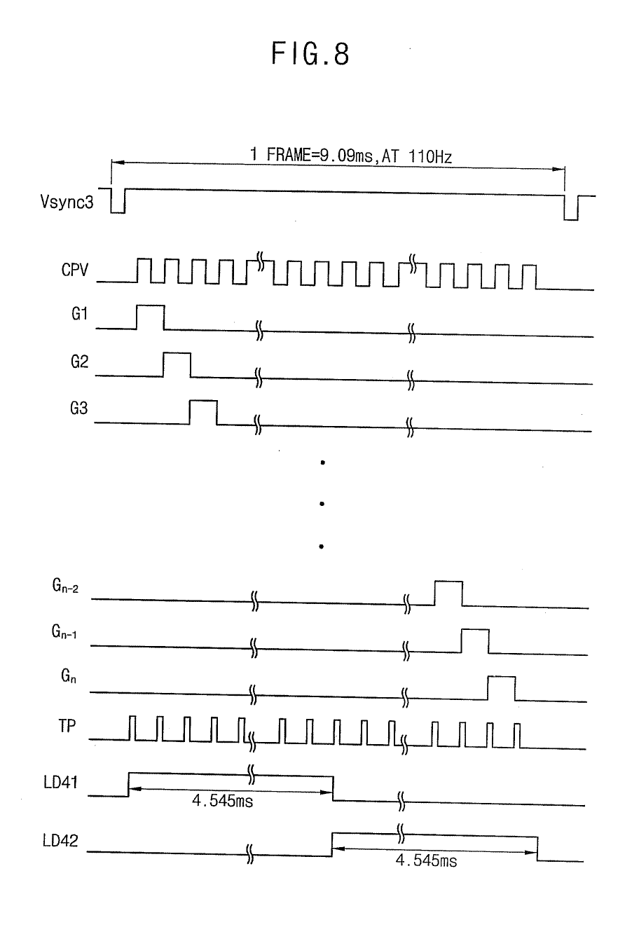

FIG. 8 is a waveform illustrating an exemplary light source driving signal according to another exemplary embodiment of the present invention.

Referring to FIGS. 5 and 8, when an operation frequency of an LCD apparatus is changed from about 120 Hz to about 110 Hz, a time corresponding to one frame is about 9.09 ms.

In an operation, a scanning control part 356 according to another exemplary embodiment of the present invention applies a first light source driving signal LD41 for driving a first light source group to the first transformer 3542 in response to a vertical synchronization signal Vsync3.

Then, the scanning control part 356 counts the number of a clock pulse vertical signal CPV. When the number of the clock pulse vertical signal CPV is arrived at a predetermined number, the scanning control part 356 protects the first light source driving signal LD41 applied to the first transformer 3542, and applies a second light source driving signal LD42 for driving a second light source group to the second transformer 3544. In this exemplary embodiment, the clock pulse vertical signal CPV may control an outputting gate on/off signals.

In the exemplary embodiment, the predetermined number is a value that the number of the clock pulse vertical signal CPV corresponding to one frame is divided by the number of the light sources in the light source part 352. Therefore, the first light source driving signal LD41 is applied to the first transformer 3542 for a time of about 4.545 ms, and the second light source driving signal LD42 is applied to the second transformer 3544 for the remaining time that is about 4.545 ms.

Therefore, even though an operating frequency of an LCD apparatus is changed, the light source driving signals for driving the light source groups that are adopted in the changed operation frequency are provided, so that a variation of emitting time between the light source groups is not substantially generated.

In this exemplary embodiment, the first transformer part may be driven based on a vertical synchronization signal Vsync provided from an external device, and then the remaining transformers may be sequentially driven by counting the number of the clock pulse vertical signal CPV (see FIG. 8) provided from an external device.

Alternatively, the first transformer part may be driven based on a vertical synchronization signal Vsync provided from an external device, and then the remaining transformers may be sequentially driven by counting the number of the load signal TP (see FIG. 8) provided from an external device. The load signal TP is a signal for instructing to output an image data signal to a plurality of data lines after the image data signal is transferred to the data lines.

Although exemplary embodiments of the present invention have been described, it is understood that the present invention should not be limited to these embodiments but various changes and modifications can be made by one of ordinary skill in the art within the spirit and scope of the present invention as hereinafter claimed.

What is claimed is:

1. A backlight apparatus comprising:
a plurality of light source parts including at least one light source, respectively;
a plurality of transformers providing the light source parts with power, respectively; and
a scanning control part driving a first transformer based on a vertical synchronization signal (Vsync) provided from an external device and sequentially driving at least one of remaining transformers based on a clock signal provided from the external device.

2. The backlight apparatus of claim 1, wherein the clock signal is one of a horizontal synchronization signal (Hsync), a load signal (TP) which instructs outputting of an image data signal to a plurality of data lines after the image data signal is transferred to the data lines, and a clock pulse vertical signal (CPV) which controls an output of gate on/off signals.

3. The backlight apparatus of claim 1, wherein the scanning control part counts the clock signal to control driving of the transformers sequentially.

4. The backlight apparatus of claim 1, wherein the scanning control part controls power provided to the first transformer in response to the vertical synchronization signal (Vsync), protects power provided to an (n)-th transformer when a count number of the clock signal is conditioned by a predetermined number, and controls a power provided to an (n+1)-th transformer, wherein ‘n’ is a natural number.

5. The backlight apparatus of claim 4, wherein the predetermined number is a value of a clock number corresponding to one frame divided by the number of the light source parts.

6. The backlight apparatus of claim 1, wherein the scanning control part comprises:
a clock counter which counts the vertical synchronization signal (Vsync) and the clock signal to output a high signal or a low signal; and
a switch which controls a driving of at least one of the transformers based on the high signal or the low signal.

7. The backlight apparatus of claim 1, wherein each of the light sources includes at least one of a cold cathode florescent lamp, an external electrode florescent lamp and a light-emitting diode.

8. The backlight apparatus of claim 1, wherein the scanning control part controls each of the transformers to have a substantially identical activation interval.

9. The backlight apparatus of claim 1, further comprising:
a power providing part including a plurality of metal-oxide semiconductor transistors in a full-bridge arrangement; and
a switching part electrically connected to the transformers and the power providing part to optionally provide the transformers with power outputted from the power providing part in response to a control of the scanning control part.

10. A method of driving a backlight apparatus including a plurality of light source parts, the method comprising:
(i) activating a first light source part based on a vertical synchronization signal (Vsync);
(ii) counting a clock signal inputted from an external device;
(iii) deactivating an activated light source part as a count value is conditioned by a predetermined number, and activating a following light source part;
(iv) resetting the count value;
(v) checking whether a vertical synchronization signal (Vsync) is inputted or not, and feedbacking step (i) when the vertical synchronization signal (Vsync) is inputted; and
(vi) feedbacking step (ii) when the vertical synchronization signal (Vsync) is not inputted in step (v).

11. The method of claim 10, wherein the clock signal is one of a horizontal synchronization signal (Hsync), a load signal (TP) which instructs outputting of an image data signal to a plurality of data lines after the image data signal is transferred to the data lines, and a clock pulse vertical signal (CPV) which controls an output of gate on/off signals.

12. The method of claim 10, wherein the predetermined number is a value of a clock number corresponding to one frame divided by the number of the light source parts.

13. The method of claim 10, wherein each of the light source parts includes at least one of a cold cathode florescent lamp, an external electrode florescent lamp and a light-emitting diode.

14. A liquid crystal display apparatus comprising:
a liquid crystal display part including a timing control part receiving a first image signal and a synchronization signal from an external device to output a second image signal, a first control signal and a second control signal, a data driving part outputting a plurality of data voltages based on the second image signal and the first control signal, a gate driving part outputting a plurality of gate voltages based on the second control signal, and a liquid crystal display panel displaying an image based on the gate voltages and the data voltages; and
a backlight apparatus providing the liquid crystal display panel with light, the backlight apparatus comprising:
a plurality of light source parts including at least one light source, respectively;
a plurality of transformers providing the light source parts with power, respectively; and
a scanning control part driving a first transformer based on a vertical synchronization signal (Vsync) provided from an external device and sequentially driving at least one of remaining transformers based on a clock signal provided from the external device.

15. The liquid crystal display apparatus of claim 14, wherein the clock signal comprises a horizontal synchronization signal (Hsync) provided from a graphic controller to the timing control part.

16. The liquid crystal display apparatus of claim 14, wherein the clock signal is a load signal (TP) included in the first control signal to instruct an outputting of an image data signal to a plurality of data lines after the image data signal is transferred to the data lines.

17. The liquid crystal display apparatus of claim 14, wherein the clock signal is a clock pulse vertical signal (CPV) included in the second control signal to control an output of gate on/off signals corresponding to the gate voltages.

18. The liquid crystal display apparatus of claim 14, wherein each of the light sources includes at least one of a cold cathode florescent lamp, an external electrode florescent lamp and a light-emitting diode.

19. The liquid crystal display apparatus of claim 14, wherein the scanning control part comprises:
a clock counter counting the vertical synchronization signal (Vsync) and the clock signal to output a high signal or a low signal; and
a switch controlling a driving of at least one of the transformers based on the high signal or the low signal.

20. The liquid crystal display apparatus of claim 14, wherein the backlight apparatus further comprises:
a power providing part including a plurality of metal-oxide semiconductor transistors in a full-bridge arrangement; and
a switching part electrically connected to the transformers and the power providing part, the switching part selectively providing the transformers with power provided from the power providing part based on a controlling of the scanning control part.
